(19) United States
(12) Patent Application Publication
(10) Pub. No.: US 2026/0058278 A1
(43) Pub. Date: Feb. 26, 2026

(54) VEHICLE BATTERY MOUNTING STRUCTURE

(71) Applicants: Hyundai Motor Company, Seoul (KR); Kia Corporation, Seoul (KR)

(72) Inventors: Hyun Wook JEON, Hwaseong-si (KR); Jae Hyeon JU, Hwaseong-si (KR); Kyu Bin CHUNG, Hwaseong-si (KR); Min Sik BANG, Hwaseong-si (KR); Hwan NOH, Hwaseong-si (KR); Hyeon Su JIN, Hwaseong-si (KR); Min Je JO, Hwaseong-si (KR)

(73) Assignees: Hyundai Motor Company, Seoul (KR); Kia Corporation, Seoul (KR)

(21) Appl. No.: 19/010,453

(22) Filed: Jan. 6, 2025

(30) Foreign Application Priority Data
Aug. 21, 2024 (KR) 10-2024-0112245

(51) Int. Cl. H01M 50/242; B60K 1/04; B60L 50/64; H01M 50/204; H01M 50/249; H01M 50/262; H01M 50/271

(52) U.S. Cl. CPC H01M 50/242; B60K 1/04; B60L 50/64; H01M 50/204; H01M 50/249; H01M 50/262; H01M 50/271; H01M 2220/20

(57) ABSTRACT

A vehicle battery mounting structure includes a plurality of battery modules disposed in a plane, each battery module including at least one insert bar inserted between a plurality of battery cells stacked in one direction, a pair of endplates respectively provided at first and second end portions of the stacked battery cells, and at least one coupling member connecting and securing the insert bar to the endplates at first and second end portions of the at least one coupling member.

### CROSS REFERENCE TO RELATED APPLICATION

The present application claims priority to Korean Patent Application No. 10-2024-0112245 filed on Aug. 21, 2024, the entire contents of which is incorporated herein for all purposes by this reference.

### BACKGROUND OF THE PRESENT DISCLOSURE

### Field of the Present Disclosure

The present disclosure relates to a technology for a structure for mounting a battery in a vehicle such as an electric vehicle.

### Description of Related Art

Hybrid vehicles, electric vehicles, or the like are provided with batteries to provide power required to drive the vehicles.

Typically, the battery is mounted in the vehicle in a form of a battery pack, in which a plurality of battery modules is housed, wherein the battery module includes a plurality of battery cells.

The battery pack includes components such as a battery casing, a plurality of battery modules housed in the battery casing, a battery management assembly (BMA), and a power relay assembly (PRA).

The battery casing may include a lower casing part forming an accommodation space for accommodating the battery modules, an upper cover coupled to an upper side of the lower casing part to seal the accommodation space, and a plurality of internal reinforcement members spanning the interior of the battery casing to provide rigidity to the battery casing to effectively protect the battery modules accommodated therein.

While it is advantageous to increase the payload of internal reinforcement members provided in the battery casing to sufficiently secure the rigidity of the battery casing and the battery pack, it tends to be desirable to reduce the payload of parts such as the internal reinforcement members to increase the payload of battery modules or battery cells accommodated in the battery casing for improving the mileages of electric vehicles or the like.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle battery mounting structure that enables an increase in the payload of battery cells in a battery casing to increase the mileage range of a vehicle, while ensuring sufficient rigidity of a battery pack to effectively protect the battery modules accommodated in the battery casing even in the event of a vehicle collision accident or the like.

The objective of the present disclosure is not limited to the above objective, and other objectives not mentioned will be apparent to those skilled in the art from the following description.

In an aspect of the present disclosure, a vehicle battery mounting structure includes a plurality of battery modules disposed in a plane, each battery module including: at least one insert bar inserted between a plurality of battery cells stacked in one direction thereof; a pair of endplates respectively provided at first and second end portions of the stacked battery cells; and at least one coupling member connecting and securing the insert bar to the endplates at first and second end portions of the at least one coupling member.

The insert bar may include: a body section in surface-contact with the battery cell; and first and second protrusions protruding from the body section in opposite directions perpendicular to a stacking direction of the battery cells.

The body section of the insert bar may be internally provided with at least one partition wall extending linearly in the protruding direction of the first and second protrusions.

The first protrusion and the second protrusion may be respectively formed to protrude laterally in opposite directions from two partition walls vertically adjacent to each other.

The first protrusion and the second protrusion may be respectively formed to protrude at different positions in height on opposite lateral sides of the body section.

One of the first protrusion or the second protrusion may be coupled to one of a first internal member or a bar mounting bracket provided inside the battery casing, wherein the first internal member is disposed to extend along the stacking direction of the battery cells and across the space between the battery modules accommodated in the battery casing, and wherein the bar mounting bracket may be mounted to protrude inwardly from an internal casing wall of the battery casing.

The battery modules may be disposed in a plane in the battery casing, wherein the insert bars of respective battery modules are mounted in alignment with each other along a direction perpendicular to the stacking direction of the battery cells of the battery module.

The at least one coupling member may include: a module cover covering the entire of an upper side or a lower side of the stacked battery cells of the battery module; and at least one clamp formed in a form of a band extending along the stacking direction of the stacked battery cells.

The module cover may be coupled to the pair of endplates, at both end portions, respectively, and to the insert bar at a portion facing the insert bar.

The clamp may include a curved portion curved toward the insert bar at a portion facing the insert bar, wherein the clamp is coupled to the pair of endplates, at first and second end portions of the clamp, respectively, and to the insert bar at the curved portion.

The endplate may include a mounting flange protruding in the stacking direction of the battery cells, wherein the mounting flange may be coupled to a second internal member extending in a direction perpendicular to the stacking direction of the battery cells accommodated in the battery casing, and the mounting flange may be provided with at least one mounting hole through which a mounting bolt passes to couple the mounting flange to the second internal member.

The mounting hole may be formed as a slot elongated in the stacking direction of the battery cells.

The second internal member may be formed as a single member provided across the battery casing to support the plurality of battery modules disposed in a longitudinal direction of the second internal member.

In another aspect of the present disclosure, a battery module includes: at least one insert bar inserted between a plurality of battery cells stacked in one direction thereof; a pair of endplates respectively provided at first and second end portions of the stacked battery cells; and at least one coupling member connecting and securing the insert bar to the endplates at first and second end portions of the at least one coupling member.

The insert bar may include: a body section in surface-contact with the battery cell; and first and second protrusions protruding from the body section in opposite directions perpendicular to a stacking direction of the battery cells.

The body section of the insert bar may be internally provided with at least one partition wall extending linearly in the protruding direction of the first and second protrusions, wherein the first protrusion and the second protrusion may be respectively formed to protrude laterally in opposite directions from two partition walls vertically adjacent to each other.

The at least one coupling member may include: a module cover covering the entire of an upper side or a lower side of the stacked battery cells of the battery module; and at least one clamp formed in a form of a band extending along the stacking direction of the stacked battery cells.

The module cover may be coupled to the pair of endplates, at both end portions, respectively, and to the insert bar at a portion facing the insert bar, and wherein the clamp may include a curved portion curved toward the insert bar at a portion facing the insert bar, wherein the clamp is coupled to the pair of endplates, at first and second end portions of the clamp, respectively, and to the insert bar at the curved portion.

The endplate may include a mounting flange protruding in the stacking direction of the battery cells, wherein the mounting flange may be provided with at least one mounting hole through which a mounting bolt passes.

The mounting hole may be formed as a slot elongated in the stacking direction of the battery cells.

The present disclosure may increase the payload of battery cells in the battery casing to increase the mileage range of a vehicle, while ensuring sufficient rigidity of the battery pack to effectively protect the battery modules accommodated in the battery casing even in the event of a vehicle collision accident or the like.

The present disclosure may provide a buffer space between the battery casing and the battery modules accommodated in the battery casing to protect the battery modules more effectively in the event of a side collision of a vehicle.

The present disclosure may provide an adequate surface pressure of the plurality of battery cells stacked to form the battery module to ensure more stable and robust support performance for the swelling phenomenon of the battery cells.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective diagram illustrating a battery module according to an exemplary embodiment of the present disclosure;

FIG. 2 is a diagram illustrating the state of an insert bar being inserted between the battery cells forming the battery module of FIG. 1;

FIG. 3 is an exploded perspective diagram illustrating the battery module of FIG. 1;

FIG. 4 is a cross-sectional diagram taken along line IV-IV of FIG. 1;

FIG. 5 is a cross-sectional diagram taken along line V-V of FIG. 1;

FIG. 6 is a diagram illustrating a battery module with a plurality of insert bars inserted;

FIG. 7 is a diagram illustrating the state of the battery module of FIG. 1 being mounted in the battery casing;

FIG. 8 is a top diagram illustrating the battery casing in which the battery modules of FIG. 1 are inserted;

FIG. 9 is a cross-sectional diagram taken along line IX-IX of FIG. 8;

FIG. 10 is a diagram illustrating the state of a second internal member supporting the battery modules of FIG. 8 when swelling occurs in the battery modules; and

FIG. 11 is a conceptualized detailed diagram illustrating portion A of FIG. 10.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In describing exemplary embodiments of the present disclosure, when it is determined that the detailed description of the relevant technologies in the related art would obscure the gist of the exemplary embodiments of the present disclosure, the detailed description thereof will be omitted. Furthermore, the appended drawings are merely intended to be able to readily understand the exemplary embodiments included herein, and thus the technical idea included herein is not limited by the appended drawings, and it should be understood to include all changes, equivalents, and substitutions included in the idea and technical scope of the present disclosure.

Although the terms “first”, “second”, etc. may be used herein to describe various elements, these elements should not be limited by these terms. These terms are only used to distinguish one element from another element.

As used herein, the singular forms “a”, “an”, and “the” are intended to include the plural forms as well, unless the context clearly indicates otherwise.

It should be understood that the terms “include”, “have”, etc. used herein specify the presence of stated features, integers, steps, operations, elements, components, or combinations thereof, but do not preclude the presence or addition of one or more other features, integers, steps, operations, elements, components, or combinations thereof.

As used in the following description, the suffixes “module” and “section” for components are provided or used for ease of description only and are not intended to include a distinct meaning or role in themselves.

When a component is referred to as being “connected” or “coupled” to another component, it should be understood not only that the component may be directly connected or coupled to that other component, but also that there may be other component(s) between them. On the other hand, when a component is referred to as being “directly connected” or “directly coupled” to another component, it should be understood that there may be no other component(s) between them.

Furthermore, a unit or control unit, which is included in the names such as motor control unit (MCU), hybrid control unit (HCU), etc., is merely a widely used term for controllers that control predetermined functions of a vehicle, but does not imply a generic function unit.

The controller may include a communication device for communicating with other controllers or sensors to control their own functions to perform, a memory for storing operating system or logic instructions and input/output information, and one or more processors for performing judgments, calculations, decisions, etc. necessary for controlling their own functions to perform.

Hereinafter, various exemplary embodiments included herein will be described in detail with reference to the accompanying drawings, wherein identical or similar components are assigned the same reference numerals, and a redundant description thereof will be omitted.

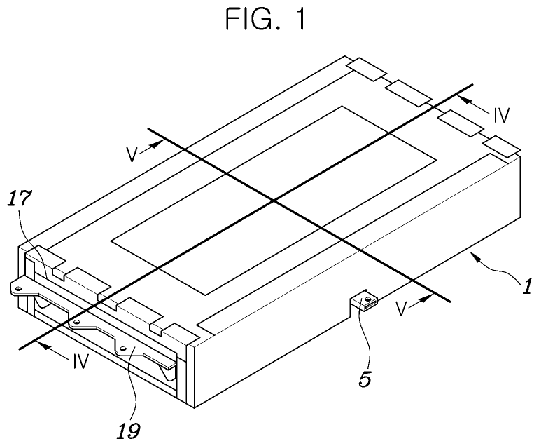

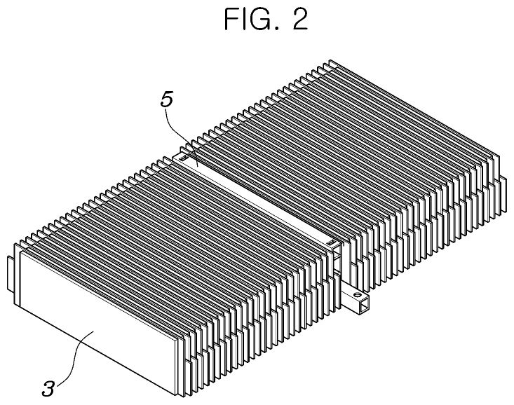

FIG. 1 is a perspective diagram illustrating a battery module 1 according to an exemplary embodiment of the present disclosure, and FIG. 2 is a perspective diagram illustrating only battery cells 3 and an insert bar 5 inserted between the battery cells 3, forming the battery module 1 of FIG. 1.

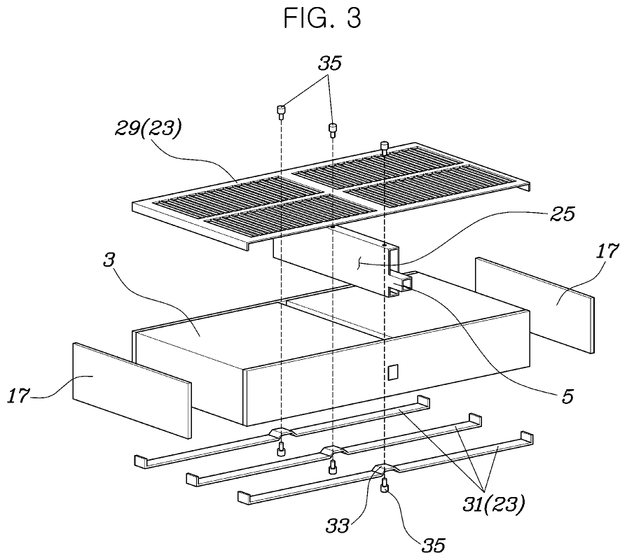

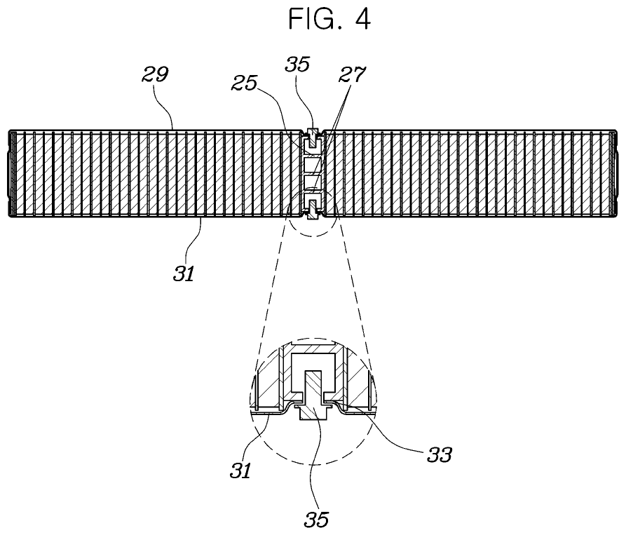

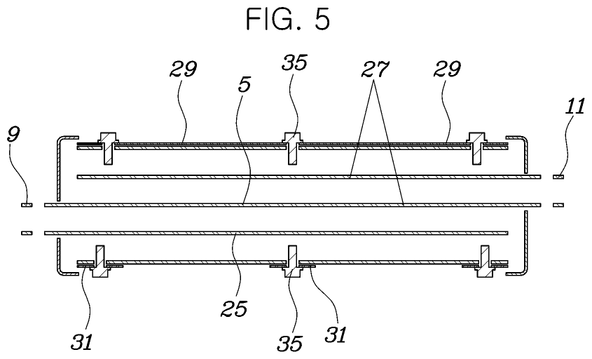

FIG. 3 is an exploded perspective diagram illustrating the battery module 1 of FIG. 1, FIG. 4 is a cross-sectional diagram taken along line IV-IV of FIG. 1, and FIG. 5 is a cross-sectional diagram taken along line V-V of FIG. 1, wherein FIG. 5 substantially shows a cross-section of the insert bar 5.

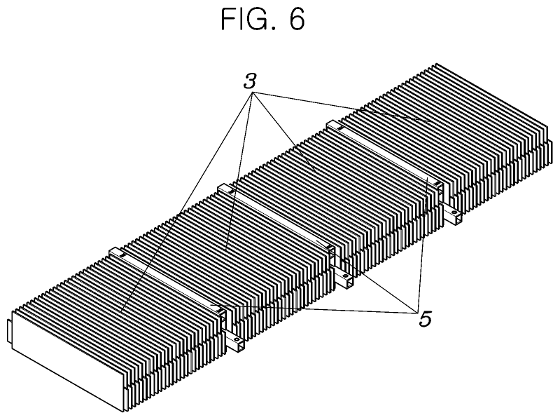

FIG. 6 is a diagram illustrating a battery module 1 in which a plurality of insert bars 5 are inserted, illustrating that the battery module 1 may be assembled with the plurality of insert bars 5 inserted, unlike the battery module 1 of FIG. 1, FIG. 2, FIG. 3, FIG. 4, and FIG. 5.

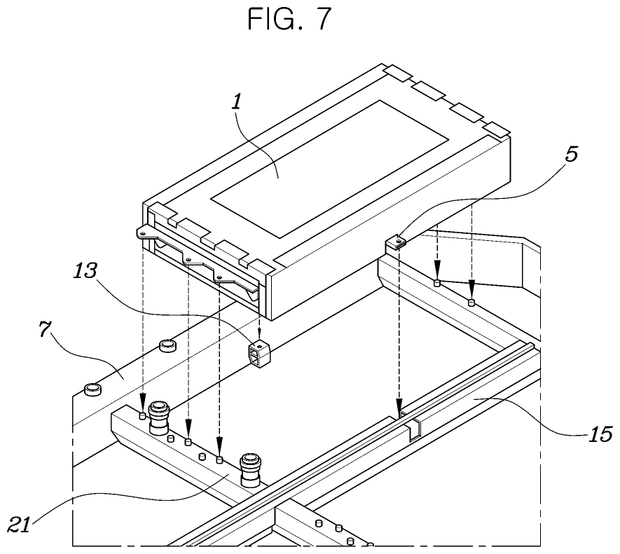

FIG. 7 is a diagram illustrating the battery module 1 of FIG. 1 being mounted in a battery casing 7, wherein a first protrusion 9 and a second protrusion 11 protruding laterally in opposite directions from both sides of the battery module 1 are fixed to a bar mounting bracket 13 and a first internal member 15, respectively, and a mounting flange 19 of an endplate 17 is fixed to a second internal member 21.

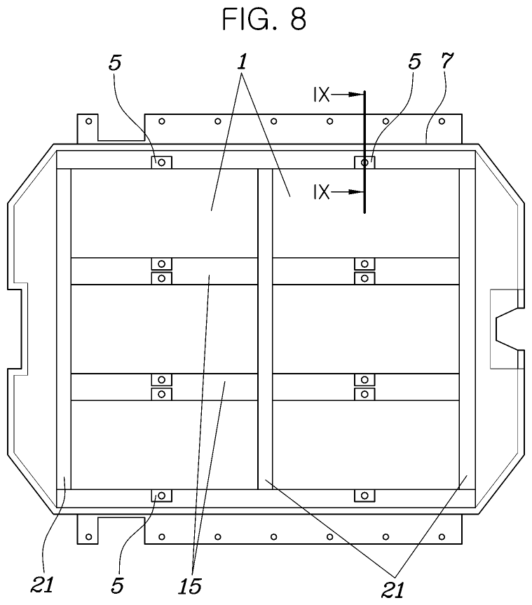

FIG. 8 is a top diagram illustrating the battery casing 7 in which the battery modules 1 of FIG. 1 are inserted with the insert bar 5 inserted in the center portion of each battery module 1.

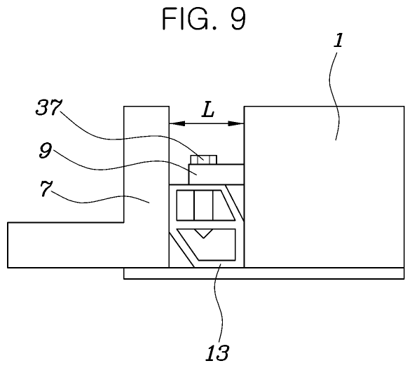

FIG. 9 is a cross-sectional diagram taken along line IX-IX of FIG. 8, showing that the first protrusion 9 is connected to the bar mounting bracket 13 by a mounting bolt 37, so that a separation distance L is secured between the battery casing 7 and the battery module 1 accommodated therein, providing a space which may cushion the shock in the event of a collision accident or the like.

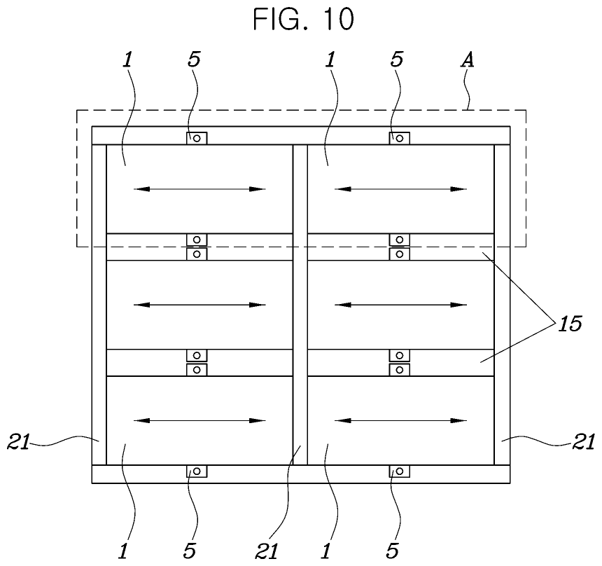

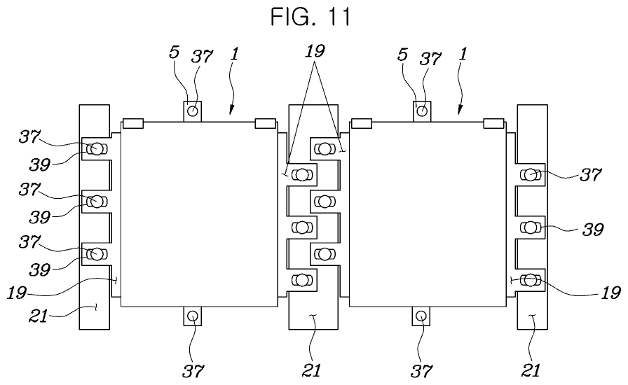

FIG. 10 is a diagram illustrating only the portion of FIG. 8 where the battery modules 1 are provided, showing that the second internal member 21 supports the battery modules 1 in the event of swelling, and FIG. 11 is a detailed diagram conceptually illustrating portion A of FIG. 10, focusing on the connected state of the mounting bolts 37.

For reference, the arrows in FIG. 10 represent pressures generated by the swelling of the battery cells 3.

Referring to FIGS. 1 to 11, a vehicle battery mounting structure of the present disclosure includes a plurality of battery modules 1 disposed in a plan, wherein each battery module includes: at least one insert bar 5 inserted between a plurality of battery cells 3 stacked in one direction thereof; a pair of endplates 17 provided at both end portions of the stacked battery cells 3; and at least one coupling member 23 for connecting and securing the insert bar 5 to the pair of endplates 17.

In other words, according to the vehicle battery mounting structure, as illustrated in FIGS. 7 and 8, the plurality of battery modules 1 are disposed in a plan in the battery casing 7 so that the insert bars 5 of respective battery modules 1 are aligned with each other along a direction perpendicular to the stacking direction of the battery cells 3 of the battery modules 1, allowing the insert bars 5 in the battery modules 1 to further provide the rigidity to the battery casing 7 in addition to its own function.

For example, when an external impact is applied in the longitudinal direction of the insert bars 5, the insert bars 5 may act as a support for such an external impact, ultimately protecting the battery cells 3 of the battery modules 1.

This makes it possible to eliminate some of internal components that are conventionally provided in the battery casing 7, increasing the payload of the battery cells 3 relatively, while ensuring sufficient rigidity of the battery pack by the insert bars 5, which ultimately increases the mileage of electric vehicles or the like, as well as ensuring the required rigidity and protection of the battery pack at or above the conventional level.

The insert bar 5 includes a body section 25 in surface-contact with the battery cell 3, and first and second protrusions 9 and 11 respectively protruding laterally from the body section 25 in opposite directions perpendicular to the stacking direction of the battery cells 3.

In other words, the body section 25 is formed in a shape including a plane substantially the same as that of adjacent battery cells 3, which helps form a surface pressure of the battery cells 3, and the first protrusion 9 and second protrusion 11 are respectively formed to protrude laterally in opposite directions from the battery module 1.

The body section 25 of the insert bar 5 may be internally provided with at least one partition wall 27, which may be formed to include a shape extending linearly in the protruding direction of the first protrusion 9 and the second protrusion 11.

In other words, the insert bar 5 may be from a hollow member including a partition wall 27 therein, so that the insert bar may be formed of a metallic extruded material or the like which is elongated in the longitudinal direction of the insert bar 5.

In an exemplary embodiment of the present disclosure, the insert bar 5 includes a cross-sectional structure in the shape of an extruded material including a plurality of partition walls 27 in the body section 25, and the first protrusion 9 and the second protrusion 11 are configured in a shape formed to protrude laterally in opposite directions from two partition walls 27 disposed vertically adjacent to each other in the body section 25.

In the present way, the insert bar 5 formed from the hollow member with a plurality of partition walls 27 has minimized weight while ensuring sufficient rigidity of the battery module 1 and the battery pack.

Here, the first protrusion 9 and the second protrusion 11 may be formed to protrude at different positions in height on opposite lateral sides of the body section 25.

The first protrusion 9 and the second protrusion 11 may be provided to have a height difference, so that when adjacent battery modules 1 are mounted together, adjacent first and second protrusions 9 and 11 of the adjacent battery modules 1 vertically overlap each other and are coupled together by bolts or the like, securing a coupling force and support stiffness between the battery modules 1.

The first protrusion 9 and the second protrusion 11 are respectively coupled to a first internal member 15 and a bar mounting bracket 13 provided in the battery casing 7, wherein the first internal member 15 is disposed to extend along the stacking direction of the battery cells 3 and across the space between the battery modules 1 accommodated in the battery casing 7, and the bar mounting bracket 13 is provided to protrude inwardly from an internal wall surface of the battery casing 7.

Thus, a separation distance L as illustrated in FIG. 9 is provided between the battery module 1 and the internal wall surface of the battery casing 7 to provide a buffer space against an external impact from a collision accident or the like, effectively protecting the battery module 1 accommodated in the battery casing.

For reference, in the exemplary embodiment of the present disclosure, the first internal member 15 is elongated along the stacking direction of the battery cells 3 of the battery module 1, and the second internal member 21 is provided perpendicular to the stacking direction of the battery cells 3, i.e., perpendicular to the first internal member 15.

On the other hand, the at least one coupling member 23 is provided on the upper and lower sides of the stacked battery cells 3.

In the exemplary embodiment of the present disclosure, the at least one coupling member 23 includes a module cover 29 covering the entire of an upper side or a lower side of the stacked battery cells 3 of the battery module, and at least one clamp 31 formed in a form of a band extending along the stacking direction of the stacked battery cells 3.

The module cover 29 is coupled to the pair of endplates 17, at both end portions, respectively, and to the insert bar 5 at a portion facing the insert bar 5.

Furthermore, the clamp 31 includes a curved portion 33 curved toward the insert bar 5 at a portion facing the insert bar 5, wherein the clamp 31 is coupled to the pair of endplates 17, at both end portions, respectively, and to the insert bar 5 at the curved portion 33.

In the exemplary embodiment of the present disclosure, the coupling between the module cover 29 and the insert bar 5 and the coupling between the insert bar 5 and the clamp 31 are illustrated as being performed by a plurality of fastening bolts 35, but other fastening methods such as welding may also be used.

The endplate 17 includes a mounting flange 19 protruding in the stacking direction of the battery cells 3, wherein the mounting flange 19 is coupled to a second internal member 21 extending in a direction perpendicular to the stacking direction of the battery cells 3 accommodated in the battery casing 7, and the mounting flange 19 is provided with at least one mounting hole 39 through which a mounting bolt 37 passes to couple the mounting flange 19 to the second internal member 21.

The mounting hole 39 is formed as a slot elongated in the stacking direction of the battery cells 3. In an exemplary embodiment of the present disclosure, the slot may include a long hole.

Thus, even if swelling occurs in the battery cells 3 of the battery module 1, the swelling battery cells 3 are initially supported by the fastening force provided by the mounting bolts 37 and by the second internal member 21.

As the mounting hole 39 is formed as a long hole, it is possible to prevent fracture of the mounting bolts 37 and to provide a continuously stable support to the battery module 1 even when the mounting flange 19 is moved relative to the second internal member 21 due to the swelling of the battery cells 3.

Here, since the second internal member 21 is formed as a single member provided across the battery casing 7 to support the plurality of battery modules 1 disposed in a longitudinal direction of the second internal member 21, the pressure caused due to the swelling of the battery modules 1 may be stably supported by the second internal member 21 even when the fastening force of the mounting bolts 37 is insufficient.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery mounting structure for a vehicle, the structure comprising:
a plurality of battery modules disposed in a plane,
wherein each battery module includes:
at least one insert bar inserted between a plurality of battery cells stacked in a stacking direction;
a pair of endplates respectively provided at first and second end portions of the stacked battery cells; and
at least one coupling member connecting and securing the at least one insert bar to the endplates at first and second end portions of the at least one coupling member.

2. The battery mounting structure of claim 1, wherein the at least one insert bar includes:
a body section in surface-contact with the battery cells; and
first and second protrusions protruding from the body section in opposite directions perpendicular to the stacking direction of the battery cells.

3. The battery mounting structure of claim 2, wherein the body section of the at least one insert bar is internally provided with at least one partition wall extending linearly in a protruding direction of the first and second protrusions.

4. The battery mounting structure of claim 3, wherein the first protrusion and the second protrusion are respectively formed to protrude laterally in opposite directions from two partition walls vertically adjacent to each other.

5. The battery mounting structure of claim 2, wherein the first protrusion and the second protrusion are respectively formed to protrude at different positions in height on opposite lateral sides of the body section.

6. The battery mounting structure of claim 2,
wherein one of the first protrusion or the second protrusion is coupled to one of a first internal member or a bar mounting bracket provided inside a battery casing,
wherein the first internal member is disposed to extend along the stacking direction of the battery cells and across a space between the battery modules accommodated in the battery casing, and
wherein the bar mounting bracket is mounted to protrude inwardly from an internal casing wall of the battery casing.

7. The battery mounting structure of claim 1, wherein the battery modules are disposed in a plane in a battery casing, wherein the at least one insert bar of respective battery modules are mounted in alignment with each other along a direction perpendicular to the stacking direction of the battery cells of the battery module.

8. The battery mounting structure of claim 2, wherein the at least one coupling member includes:
a module cover covering the entire of an upper side or a lower side of the stacked battery cells of the battery module; and
at least one clamp formed in a form of a band extending along the stacking direction of the stacked battery cells.

9. The battery mounting structure of claim 8, wherein the module cover is coupled to the pair of endplates, at first and second end portions of the module cover, respectively, and to the at least one insert bar at a portion facing the at least one insert bar.

10. The battery mounting structure of claim 8,
wherein the at least one clamp includes a curved portion curved toward the at least one insert bar at a portion facing the at least one insert bar, and
wherein the at least one clamp is coupled to the pair of endplates, at first and second end portions of the at least one clamp, respectively, and to the at least one insert bar at the curved portion.

11. The battery mounting structure of claim 1,
wherein each endplate includes a mounting flange protruding in the stacking direction of the battery cells,
wherein the mounting flange is coupled to a second internal member extending in a direction perpendicular to the stacking direction of the battery cells accommodated in a battery casing, and
wherein the mounting flange is provided with at least one mounting hole through which a mounting bolt passes to couple the mounting flange to the second internal member.

12. The battery mounting structure of claim 11, wherein the at least one mounting hole is formed as a slot elongated in the stacking direction of the battery cells.

13. The battery mounting structure of claim 11, wherein the second internal member is formed as a single member provided across the battery casing to support the plurality of battery modules disposed in a longitudinal direction of the second internal member.

14. A battery module comprising:
at least one insert bar inserted between a plurality of battery cells stacked in a stacking direction;
a pair of endplates respectively provided at first and second end portions of the stacked battery cells; and
at least one coupling member connecting and securing the at least one insert bar to the endplates at first and second end portions of the at least one coupling member.

15. The battery module of claim 14, wherein the at least one insert bar includes:
a body section in surface-contact with the battery cells; and
first and second protrusions protruding from the body section in opposite directions perpendicular to the stacking direction of the battery cells.

16. The battery module of claim 15,
wherein the body section of the at least one insert bar is internally provided with at least one partition wall extending linearly in a protruding direction of the first and second protrusions, and
wherein the first protrusion and the second protrusion are respectively formed to protrude laterally in opposite directions from two partition walls vertically adjacent to each other.

17. The battery module of claim 14, wherein the at least one coupling member includes:
a module cover covering the entire of an upper side or a lower side of the stacked battery cells of the battery module; and
at least one clamp formed in a form of a band extending along the stacking direction of the stacked battery cells.

18. The battery module of claim 17,
wherein the module cover is coupled to the pair of endplates, at first and second end portions of the module cover, respectively, and to the at least one insert bar at a portion facing the at least one insert bar, and
wherein the at least one clamp includes a curved portion curved toward the at least one insert bar at a portion facing the at least one insert bar, wherein the at least one clamp is coupled to the pair of endplates, at first and second end portions of the at least one clamp, respectively, and to the at least one insert bar at the curved portion.

19. The battery module of claim 14,
wherein each endplate includes a mounting flange protruding in the stacking direction of the battery cells, and
wherein the mounting flange is provided with at least one mounting hole through which a mounting bolt passes.

20. The battery module of claim 19, wherein the at least one mounting hole is formed as a slot elongated in the stacking direction of the battery cells.
